(19) United States
(12) Patent Application Publication
(10) Pub. No.: US 2012/0169571 A1
(43) Pub. Date: Jul. 5, 2012

(54) DISPLAY PANEL WITH NETWORK COMMUNICATION FUNCTION

(76) Inventor: Chun-Hsiao WANG, Chungho City (TW)

(21) Appl. No.: 12/982,337

(22) Filed: Dec. 30, 2010

(51) Int. Cl. G09G 5/00

(52) U.S. Cl. 345/1.2

(57) ABSTRACT

A display panel includes a display module accommodated in a housing and comprising an electric circuit mounted on the border the glass substrate thereof beyond the display zone and display driver IC chips electrically connected with the electric circuit, and a circuit board mounted in the housing at one side adjacent to the display driver IC chips and comprising a power processing unit for receiving and processing power supply to provide the circuit board and the display module with the necessary working power, a computing unit carrying therein an embedded system and electrically connected with the power processing unit for processing a network signal into a video signal and a connection module electrically connected with the computing unit for receiving an external network signal and running programmable digital signal transmission.

### BACKGROUND OF THE INVENTION

1. Field of the Invention

The present invention relates to display technology and more particularly, to a display panel with network communication function in which the display driver IC chips are arranged on the border area of the glass substrate thereof beyond the display zone, and the circuit board which consists of a power processing unit, a computing unit and a connection module is mounted in the housing at one side of the display panel and adjacent to the display driver IC chips for processing a network signal into a video signal for display. Thus, the display panel has a small size characteristic and provides a network communication function.

2. Description of the Related Art

Following fast development of computer technology, computer has become a requisite tool in our daily living for word processing, data management, design and graphing. A computer system can be used at home for playing audio and video, searching data, making online communication with friends, processing graphic data, etc. Further, computer has also been intensively used in hospitals for patient record management and examination management, in shops for inventory control, sales management and account management, and in restaurants for menu and order management, customer service inquiry and account management. Therefore, computer has become a part of our daily life.

Following the development of computer and display technology, LCD (liquid crystal display) screen has been intensively used in shops, restaurants, hospitals and many other places to substitute for CRT (cathode ray tube) screen for the advantage of small dimension. In shops or hospitals, the computers and the display devices are used in office rooms or counters by staffs. Thus, a consumer or patient can only obtain related information (about disease, subscription, consumed amount, order sheet, etc.) from the staff of the shop or hospital. In case of a mistake of the staff, a consumer or patient may obtain wrong information. Further, in a restaurant or bar shop, a serviceman or servicewoman may stands on the entry for guiding every client to the seat. A client may ask another serviceman or servicewomen in the shop to change the seat after having taken a seat. At this time, the serviceman or servicewoman at the entry may be unable to know the actual situation and the serviceman or servicewomen in the shop may directly tell the serviceman or servicewoman at the entry about the situation with a load voice or through an intercom. This way of management is inconvenient and wastes time.

If to install a display screen on the site to provide video information for viewing by consumers and service staffs, a computer must be provided with the display screen. The display screen and the computer require much installation space and may hinder people to walk or to deliver goods. Further, the installation of a computer and a display screen for public may be not workable due to limited shop space.

FIG. 4 illustrates a display panel according to the prior art. According to this design, the display panel comprises a glass substrate A, two circuit boards B respectively arranged adjacent to two adjacent sides of the glass substrate A, and bus lines C electrically connecting the circuit boards B to the circuit layout at the glass substrate A. According to this design, the housing of the display panel has a big dimension to house the glass substrate A and the two circuit boards B. Further, the circuit boards B each comprise multiple display driver IC chips B1 and a power supply module. The display driver IC chips B1 can simply receive video signals.

Therefore, it is desirable to provide a display panel, which has a small size characteristic and is capable of processing a network signal into a video signal for display. By means of the computing unit and the connection module, the circuit board enables a network signal to be directly displayed on the display module without through a computer, saving much computer installation cost and allowing for local and remote applications.

### SUMMARY OF THE INVENTION

The present invention has been accomplished under the circumstances in view. It is therefore the main object of the present invention to provide a display panel, which has a small size characteristic and is capable of processing a network signal into a video signal for display.

To achieve this and other objects of the present invention, a display panel comprises a display module accommodated in a housing and comprising an electric circuit mounted on the border the glass substrate thereof beyond the display zone and display driver IC chips electrically connected with the electric circuit, and a circuit board mounted in the housing at one side adjacent to the display driver IC chips. Thus, the dimension of the housing of the display panel is minimized.

Further, the circuit board comprises a power processing unit for receiving and processing power supply to provide the circuit board and the display module with the necessary working power, a computing unit electrically connected with the power processing unit for processing a network signal into a video signal and a connection module electrically connected with the computing unit for receiving an external network signal and running programmable digital signal transmission. By means of the computing unit and the connection module, the circuit board enables a network signal to be directly displayed on the display module without through a computer, saving much computer installation cost and allowing for local and remote applications

Further, the computing unit of the circuit board has an embedded system therein. The embedded system in the computing unit allows the user to modify the firmware, enhancing the applicability of the product.

### BRIEF DESCRIPTION OF THE DRAWINGS

FIG. 1 is an exploded view of a display panel with network communication function in accordance with the present invention.

FIG. 2 is a top plain view of a part of the present invention, illustrating the arrangement of the glass substrate and the circuit board.

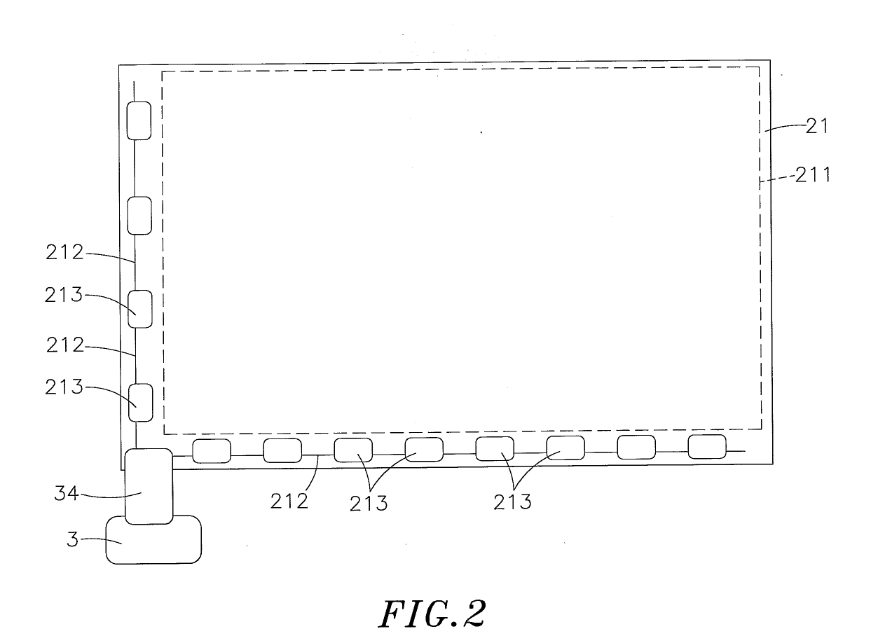

FIG. 3 is a circuit block diagram of the display panel with network communication function in accordance with the present invention.

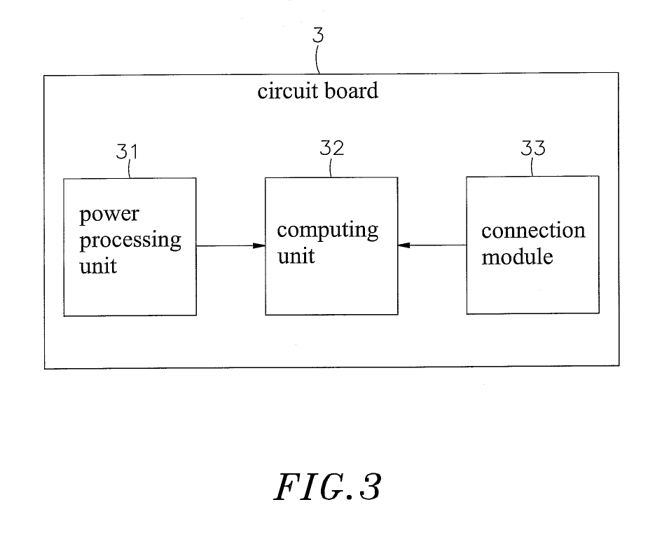

FIG. 4 is a top plain view of a part of a display panel according to the prior art.

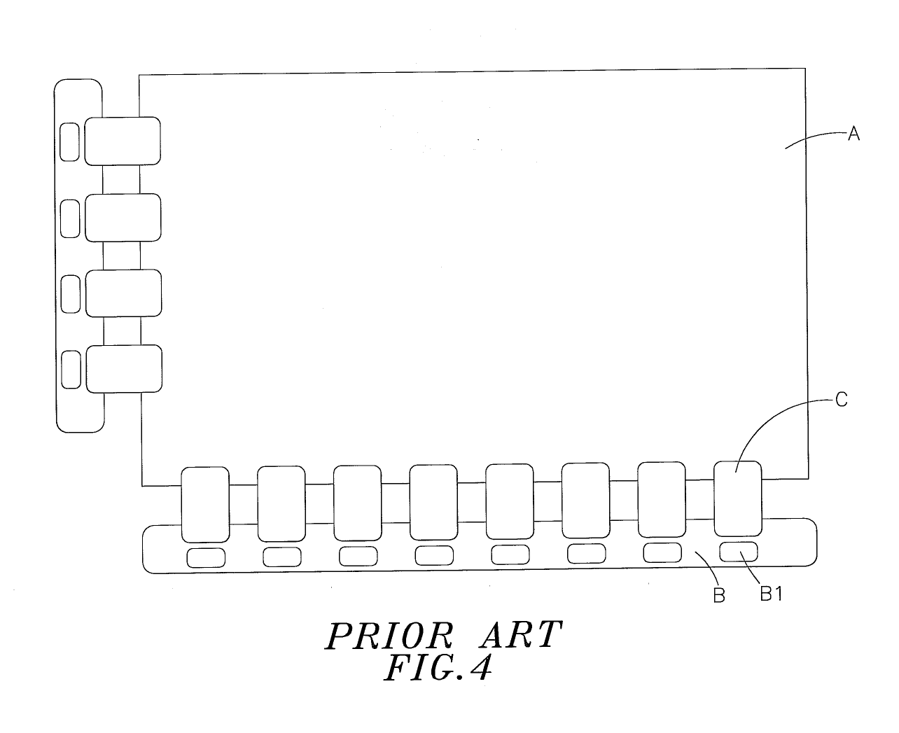

### DETAILED DESCRIPTION OF THE PREFERRED EMBODIMENT

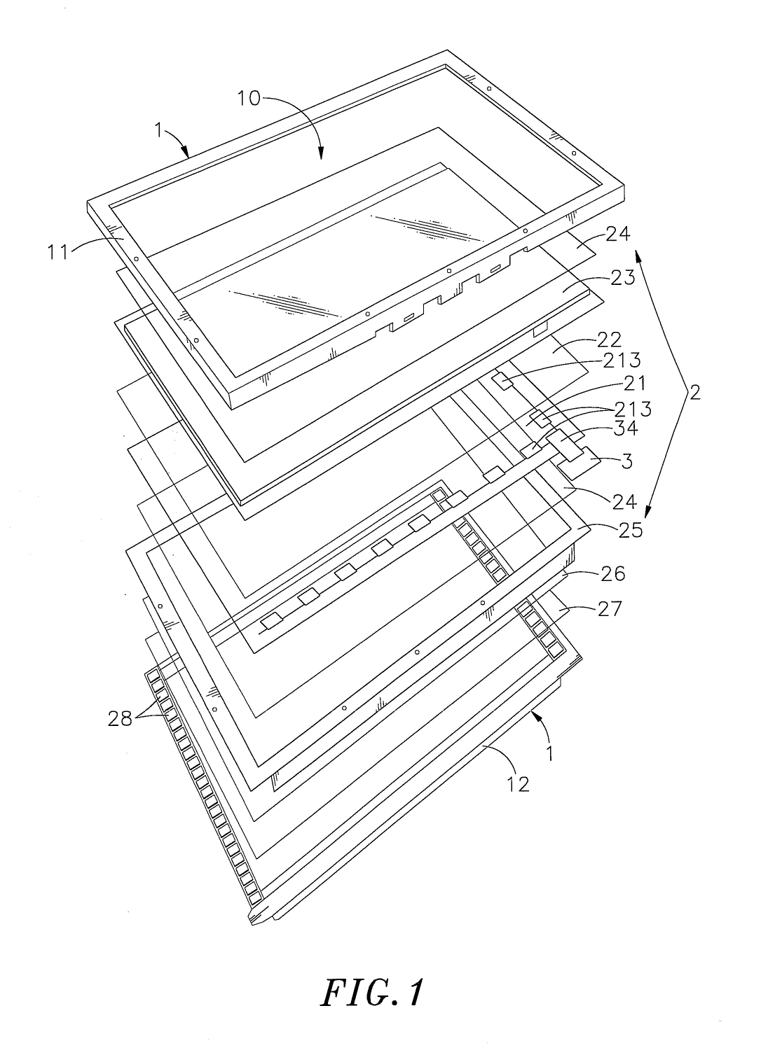

Referring to FIGS. 1˜3, a display panel with network communication function in accordance with the present invention is shown comprising a housing 1 and a display module 2 and a circuit board 3 accommodated in the housing 1.

The housing 1 comprises at least one front frame shell 11 and a backlight module 12, defining therein an accommodation chamber 10.

The display module 2 is mounted in the accommodation chamber 10 inside the housing 1, comprising a glass substrate 21, a liquid crystal layer 22, a color filter 23, two polarizers 24, a mold frame 25, a diffusing sheet 26, a light guiding plate 27 and a lamp unit 28. The glass substrate 21 comprises a display zone 211, an electric circuit 212 arranged at the border area around the display zone 211 and display driver IC chips 213 arranged at the border area around the display zone 211 and electrically connected with the electric circuit 212. The liquid crystal layer 22, the color filter 23 and one polarizer 24 are properly arranged on the front side of the glass substrate 21. The other polarizer 24, the mold frame 25, the diffusing sheets 26, the light guiding plate 27 and the lamp unit 28 are properly arranged on the back side of the glass substrate 21.

The circuit board 3 is mounted in the accommodation chamber 10 of the housing 1 at one side adjacent to the display driver IC chips 213 of the glass substrate 21 of the display module 2, comprising a power processing unit 31 adapted for receiving and processing power supply to provide the circuit board 3 and the display module 2 with the necessary working power, a computing unit 32 carrying therein an embedded system and electrically connected with the power processing unit 31 and adapted for processing a network signal into a video signal, a connection module 33 electrically connected with the computing unit 32 and adapted for receiving an external network signal and running programmable digital signal transmission, and lead wires 34 electrically connecting the computing unit 32 of the circuit board 3 to the electric circuit 212 of the glass substrate 21. Further, the connection module 33 is equipped with at least one RS232, RS422, RS485, CAN, I2C, SPI or Ethernet connector.

Further, in the aforesaid display module 2, the liquid crystal layer 22 can be arranged on the front side of the glass substrate 21. Alternatively, an additional glass substrate 21 can be arranged on the front side of the liquid crystal layer 22. The mounting positions, positioning method and video display method of the component parts 21˜28 of the aforesaid display module 2 are of the known art and not within the scope of the spirit of the present invention, therefore no further detailed description in this regard is necessary.

During the use of the display panel, connect the network cable (not shown) to the connection module 33 of the circuit board 3. When a network signal is transmitted through the network cable to the connection module 33 of the circuit board 3, the connection module 33 immediately transmits the signal to the computing unit 32 for processing into a video signal, enabling the processed video signal to be transmitted through the lead wires 34 to the electric circuit 212 of the glass substrate 21 and then to the display driver IC chips 213 so that the display driver IC chips 213 can drive the liquid crystal layer 22 to display the video.

Because the circuit board 3 is mounted in the accommodation chamber 10 of the housing 1 at one side relative to the display driver IC chips 213 of the glass substrate 21 of the display module 2, it requires less installation space in the housing 1. Thus, the size of the housing 1 can be minimized.

Further, the display driver IC chips 213 are arranged at the border area of the glass substrate 21 around the display zone 211 and not radiated by the light source. Therefore, the size of the glass substrate 21 can be minimized. Because the size of the glass substrate 21 and the size of the circuit board 3 are minimized, the size of the housing 1 is relatively minimized, saving the manufacturing cost.

Further, because the computing unit 32 of the circuit board 3 has an embedded system therein, the display panel of the present invention can be used for pulse oximetry, ECG (electrocardiography), bed side VoIP console and handy POS (point of sale) applications. Further, the product may be selectively used at different locations in different systems for different purposes. The embedded system in the computing unit 32 allows the user to modify the firmware, thereby enhancing the applicability of the product. During application, the user can connect the network cable to the connection module 33 of the circuit board 3 for direct video display without through a computer. Therefore, one single host in the whole network system is sufficient for high performance, saving much computer installation cost and allowing for local and remote applications.

Further, the power processing unit 31 and the computing unit 32 that tend to produce waste heat during operation are arranged in the circuit board 3 and electrically connecting the circuit board 3 to the electric circuit 212 of the glass substrate 21 by the lead wires 34. Thus, waste heat produced by the circuit board 3 will not be directly transferred to the liquid crystal layer 22, avoiding heat damage to the liquid crystal layer 22 and prolonging the service life of the display panel.

In actual use of the present invention, the display panel shows the following advantages and features:
1. The circuit board 3 is located on one side relative to the glass substrate 21 of the display module 2 to carry a limited number of electronic components. Thus, the circuit board 3 requires less installation space in the housing 1, and the dimension of the accommodation chamber 10 of the housing 1 can be minimized.
2. The display driver IC chips 213 are arranged on the border area of the glass substrate 21 around the display zone 211 and not to be radiated by the light source. Thus, the size of the glass substrate 21 can be minimized. Because the size of the glass substrate 21 and the size of the circuit board 3 are minimized, the size of the housing 1 is relatively minimized, saving the manufacturing cost.
3. By means of the computing unit 32 and the connection module 33, the circuit board 3 enables a network signal to be directly displayed on the display module 2 without through a computer, saving much computer installation cost and allowing for local and remote applications.
4. The computing unit 32 has an embedded system therein. Thus, the display panel can be used for medical, home and commercial applications, i.e., the display panel can be selectively used at different locations in different systems for different purposes, allowing the user to modify the firmware to enhance the applicability of the product.

In conclusion, the invention provides a display panel with network communication function, which comprises a housing 1 defining therein an accommodation chamber 10, a display module 2 that is housed in an accommodation chamber 10 of the housing 1 and comprising a glass substrate 21 defining a display zone 211 and an electric circuit 212 arranged on the border of the glass substrate 21 around the display zone 211 and display driver IC chips 213 electrically connected with the electric circuit 212, and a circuit board 3 consisting of a power processing unit 31, a computing unit 32 and a connection module 33 and disposed at one side relative to the glass substrate 21 and electrically connected to the display driver IC chips 213. The arrangement of the display driver IC chips 213 on the border area of the glass substrate beyond the light source radiation range and the design of the circuit board 3 enable the dimension of the housing 1 to be minimized. Further, by means of the computing unit 32 and the connection module 33, the circuit board 3 enables a network signal to be directly displayed on the display module 2 without through a computer, saving much computer installation cost and allowing for local and remote applications.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A display panel, comprising:
a housing defining therein an accommodation chamber;
a display module accommodated in said accommodation chamber inside said housing, said display module comprising a glass substrate defining a display zone, and an electric circuit mounted on a border area of said glass substrate beyond said display zone and at least one display driver IC chip disposed beyond said display zone and electrically connected with said electric circuit; and
a circuit board accommodated in said accommodation chamber of said housing at one side adjacent to said at least one display driver IC chip, said circuit board comprising a power processing unit adapted for receiving and processing power supply to provide said circuit board and said display module with the necessary working power, a computing unit carrying therein an embedded system and electrically connected with said power processing unit and adapted for processing a network signal into a video signal, and a connection module electrically connected with said computing unit and adapted for receiving an external network signal and running programmable digital signal transmission.

2. The display panel as claimed in claim 1, wherein said housing comprises at least one front frame shell and a backlight module.

3. The display panel as claimed in claim 1, wherein said display module further comprises a liquid crystal layer, a color filter and a polarizer arranged on a front side relative to said glass substrate.

4. The display panel as claimed in claim 1, wherein said display module further comprises a polarizer, a mold frame, a diffusing sheet, a light guiding plate and a lamp unit arranged on a rear side relative to said glass substrate.

5. The display panel as claimed in claim 1, wherein said circuit board further comprises a plurality of lead wires electrically connecting said computing unit to said electric circuit of said display module.

6. The display panel as claimed in claim 1, wherein said connection module of said circuit board is equipped with at least one of RS232, RS422, RS485, CAN, I2C, SPI or Ethernet connectors.
